(19) United States
(12) Patent Application Publication
(10) Pub. No.: US 2011/0153611 A1
(43) Pub. Date: Jun. 23, 2011

(54) EXTRACTING DATA FROM A REPORT DOCUMENT

(76) Inventors: ANIL BABU ANKISETTIPALLI, Bangalore (IN); Prashanth Pai, Bangalore (IN); Amrita Prabhakaran, Bangalore (IN); Sumitesh Ranjan Srivastava, Bangalore (IN)

(21) Appl. No.: 12/644,030

(22) Filed: Dec. 22, 2009

(51) Int. Cl. G06F 17/30

(52) U.S. Cl. 707/740; 707/769; 707/747; 707/E17.062; 707/E17.089

(57) ABSTRACT

Disclosed are systems and methods for extracting data from a report document for analysis. A report document is retrieved from a group of report documents. Data present in the report document may include fields and associated metadata. The fields and the associated metadata present in the report are categorized as corresponding data source parameters. The data source parameters are rendered on a user interface, to receive a user definition of a scope for analyzing the data present in the report document. The data source parameters associated with the user definition are qualified to rendered result objects for each associated data source parameter. Based upon the result objects, a query is generated to define the data for analyzing the report document. Based upon a user input to the query, the data present in the report document associated to the query is extracted to generate a multi-dimensional result data.

### TECHNICAL FIELD

Embodiments of the invention generally relate to computer systems, and more particularly to methods and systems for extracting data from a report document.

### BACKGROUND

Report documents contain data retrieved from a data source. This data, a result set, is processed and formatted according to a report definition. A format of the data contained in the report document may not be perceivable by applications that use the report document. Hence, report documents work with data sources to produce simple and/or complex reports. The heterogeneous data present in the report documents can be converted to a compatible format that is perceivable by other applications. Data, even though not necessarily displayed, is stored in the report. A user can utilize the data present in the report documents for functions including interactively analyzing the data by converting the data to charts, performing mathematical operations or functions on the data, grouping the data and the like. Interacting with the data better enables the user to take business decisions. Easing the users' interaction with the report document to analyze the data based upon requirements would be desirable.

### SUMMARY OF THE INVENTION

Embodiments of the invention are generally directed to methods and systems for extracting data from a report document for analysis. A report document is retrieved from a group of report documents. Data present in the report document may include fields and associated metadata. The fields and the associated metadata present in the report are categorized as corresponding data source parameters. The data source parameters are rendered on a user interface, to receive a user definition of a scope for analyzing the data present in the report document. The data source parameters associated with the user definition are qualified to render result objects. Based upon the data source parameters and the result objects, a query is generated to define the data for analyzing the report document. The query includes the result objects associated with the user definition. Based upon a user input to the query, the data present in the report document associated with the query is extracted to generate a multi-dimensional result data.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram providing a conceptual illustration for extracting data from a report document for analysis, according to various embodiments of the invention.

FIG. 2 is a block diagram providing an illustration of an overall architecture of a system for extracting data from a report document for analysis, according to various embodiments of the invention.

FIG. 3 is a flow diagram illustrating an exemplary overall process for extracting data from a report document for analysis, according to various embodiments of the invention.

FIG. 4 is a flow diagram illustrating an exemplary process for converting the report definition and the data definition into data source parameters, according to various embodiments of the invention.

FIG. 5 is a flow diagram illustrating an exemplary process for extracting data from a report document for analysis, according to various embodiments of the invention.

FIG. 6 is a block diagram illustrating a computing environment in which the techniques described for extracting data present in a report document for analyzing can be implemented, according to various embodiments of the invention.

### DETAILED DESCRIPTION

Embodiments of the invention are generally directed to methods and systems for extracting data from a report document for analysis. The report document may be residing on a local memory of a system. Report documents generally contain data, including data specific to instances of one or more business scenarios. The report data specific to business scenarios usually exist in a form of a result set more commonly known as a table, including columns and rows. Each of these columns and corresponding rows represent an instance of the business scenario. Each column includes a header that represents an instance of the business scenario. The corresponding rows of each column include values existing for the instance represented by that column. For example, for a business scenario named “Employee Information”, a header of a column named “Date of Joining” represents the instance of the joining date of the employees. In some embodiments, the property of an element and the instance of the business scenario may be used alternatively. The junction of the column and the corresponding row of a report document is typically called a field.

The report data of such instances of a business scenario can be extracted and analyzed. To provide an option of choosing the specific instances of the business scenario for further analysis, a group of report documents that represent one or more business scenarios are presented to the user. The user may select one such report document for analyzing. Based upon the selected report document, metadata associated with the report document is retrieved. The metadata of the business document has details of the business document including the information about fields of the business scenario. The fields of the selected report document are presented to the user to define a scope for analyzing the report document. The scope for analyzing the report document represents a range of data or a choice of data fields that the user wants to analyze, which is a part of the report document. The defined scope may include one or more fields that the user may want to analyze. Based upon the scope defined by the user, the fields associated with the defined scope are determined. The associated fields and their metadata are presented to the user. The user is given an option of applying a query against the report document using the associated fields. By querying the report document using the associated fields, the user will be able to extract the data of interest for analyzing the report document. The data is extracted from the report document based upon the query defined by the user, and loaded on to a multi-dimensional result data. The multi-dimensional result data provides an analytical representation of the extracted data, which can be used to analyze the report document. The data extracted from the report document can be used to make business decisions. By utilizing this approach, the user need not go through the whole report document to make a business decision.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

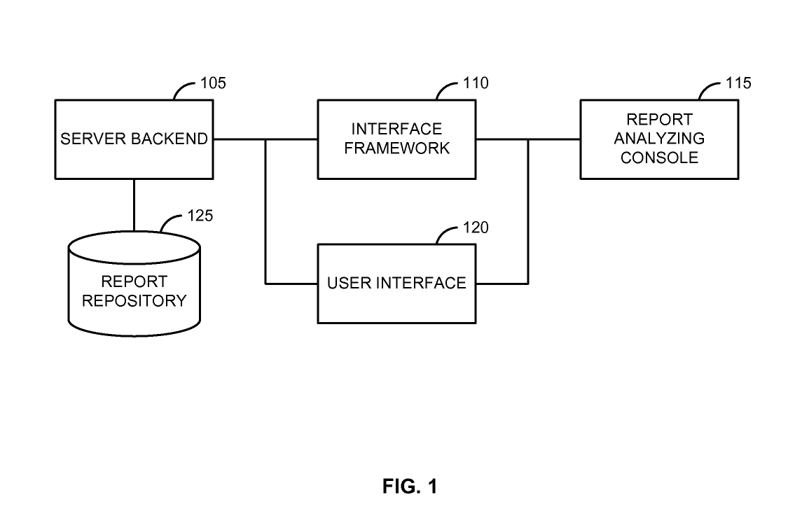

FIG. 1 is a block diagram providing a conceptual illustration for extracting data from a report document for analysis, according to various embodiments of the invention. A report document is a document that possesses a large amount of information about a corresponding business scenario. The data may be determined based upon a property of an element or an instance of the business scenario. Thus, a report document contains data, including data specific to one or more instances of the business scenario. Such data typically exists in the form of a table, including columns and rows. The data contained in the columns and the corresponding rows of the report document represent a collection of information resulting from a specific task that is performed for different properties of different elements or at different instances of the business scenario. For example, considering a business scenario “employee details”, a report document for such a business scenario may have certain properties including names of the employees, data of joining of each employee, designations of each employee and responsibilities of each employee that results from a specific task “view employee details for organization ABC” performed on the business scenario. In such a report document, header of each column represents one property included in the report, for instance “name of employee”, “date of joining”, “designation” and “responsibility”. The rows for each property includes the values for the property “name of employee” such as “MARK”, “LISA”, “ANDREW”, “MONA”, and the like.

Report repository 125 may contain many such report documents for various business scenarios. Report repository 125 also stores the metadata associated with each of the report documents. The metadata of a report document includes information about the fields contained in the report document, the header information, information about the columns in the report, type of data contained in each column, a layout information about the report document, and the like. A user may select one such report document for analysis, from report repository 125. Server backend 105 determines a report definition and a data definition of the selected report document. A report definition represents a layout of the report document and processing of data for the report document. The layout of the report document includes an arrangement of headers, footers, contents of the columns, grouping of records, and the like. Processing in a report document includes the summarization of groups, calculating values, applying filters, and the like. The report definition generates groups of one or more fields, to support report requirements. The report definition is determined using development tools (e.g., software development kit (SDK)) that are associated with the report document.

A data definition of a report document includes fields and metadata of the fields associated with the report document. For instance, the data definition of the report document includes a data structure that is necessary to define the data present in the report document. The data definition of a report document may be associated with the retrieval of data, a manner in which the data is stored in the storage medium (e.g., report repository 125), a structure that may be used to store the data resulting from a processing, and the like. A data definition may also include all the fields of the report document. The data definition represents an association or connectivity between the fields, the headers, the columns and the contents of the field, and all such field information that may exist in the report document. The report definition and the data definition of the report document may reside in report repository 125 along with the report document.

According to one embodiment, report definition and the data definition of the report document are converted to data source parameters by interface framework 110. A data source mainly includes all the information that is necessary for retrieving data from an associated report document. The data source typically contains all the source information regarding the data of the report document. This includes connectivity parameters that are responsible for maintaining an association between various parts of the report document, for instance an association between a header of a column, the contents of the column, the type of data of the contents and the like. The data source of the selected report document includes the fields that may be utilized to analyze the report document. For every new set of data that needs to be retrieved from the report document, the connectivity information present in the data source of the report document is utilized.

To convert the report definition and the data definition of the report document, the fields and the metadata associated with the report document are categorized. Categorizing the fields and the metadata associated with the fields include exploring all the fields present in the report document and determining a field type based upon each field and the metadata associated with the field. The field type of the field may be determined based upon the information contained in the field. The field type of the fields may include data fields, summary fields, formulae fields, numeric fields, function fields and the like. In an embodiment, interface framework 110 categorizes the report document by generating a hash map, the hash map containing a structure similar to a structure of the data (e.g., the fields and its contents) present in the report document. For instance, the structure of the data present in the report document may be defined by a manner in which the fields of the report document exist in the report document, including the type of each field, and the metadata associated with that field. For example, a data field including a header “Name” may have associated metadata specifying the type of data that the field holds. Similarly, a formula field may have associated metadata specifying the formula associated with the field.

In an embodiment, the hash map may describe a hierarchical structure that may exist for the data in the report document. The information of the fields is stored in the hash map, in a structure similar to the categorized fields, where the fields and the corresponding metadata are stored in the hash map. Based upon the information in the hash map, interface framework 110 creates a structure similar to the data included in each field of the report document.

In an embodiment, interface framework 110 populates the information in the hash map based upon the data in the data definition. The data source parameters are rendered on a user interface (UI). In an embodiment, the structure in which the fields and the corresponding metadata are stored may be simplified into a set of name-value pair parameters, to be used as data source parameters, and rendered on the UI. In another embodiment, the fields that represent the data source parameters are rendered on the UI. The user is provided with an option of choosing one or more fields, thereby defining a scope for analyzing the report document. The scope for analyzing a document determines the data that the user is interested in analyzing. The scope of analyzing the report document represents a range of data that the user wants to analyze, which is a part of the report document. The defined scope includes one or more fields that the user is interested in analyzing.

Based upon the scope defined by the user, the fields of the report document that are associated with the defined scope are determined. The associated fields and their metadata are qualified by interface framework 110. The process of qualifying the fields includes determining one or more measures and dimensions corresponding to the selected fields. A dimension represents a group of one or more enumerable business objects like products, people, financial elements, and time. For example, a sales report may be viewed in dimensions of a product, a store, geography, a date, a quantity, revenue generated, and the like. A measure or a metric is a quantity as ascertained by comparison with a standard, usually denoted in some metric, for example, units sold and dollars. A measure, such as sales revenue, can be displayed for dimension customer, product and geography. For example, in a sales report, “quantity count” can be displayed for dimension “quantity”. Other measures may include sum of sales revenue, count of a store, and the like. A measure may be a result of an aggregation of identical measures for a dimension. For instance, measure “revenue” may be displayed for dimension “year”. Here, the measure describes an aggregation of all the revenues for all the years. A measure can also be displayed for each of the values or records within a dimension. A value or a record may be described as a quantity (e.g., numeric quantity) that has been defined for a particular instance of the report document.

In an embodiment, interface framework 110 identifies the type of data present in the selected fields. Numeric data type fields are identified are measures whereas non-numeric data type fields are identified as dimensions. During the process of qualifying the fields, a numeric data type may also be considered as a dimension. For instance, fields with integer data type may be considered as a dimension (e.g., field “year” including the records “2002”, “2003”, “2005” etc is considered as a dimension). In an embodiment, a cardinality of the data is used to identify dimensions within numeric fields. For example, if the number of unique values is low (e.g., below a threshold) the field can be considered a dimension. In an embodiment, if all the fields include numeric data, then absence other observations, the integer fields are considered to be dimensions.

In some embodiments, interface network 110 may be associated with a business dictionary that includes one or more patterns and corresponding details of the selected fields that would enable the identification of the type of data present in the selected fields. The business dictionary may be associated with the report document, and the manner in which the report document is analyzed. For instance, if a header of a selected field is “Sales” or “Revenue”, the business dictionary enables in identifying the field as a measure. In another embodiment, if the selected field name contains an aggregation function like sum, average, count, minimum, maximum and the like, such a field is identified as a measure. In some embodiments, techniques like this can be combined with a check to see if the field is numeric.

In an embodiment, qualifying the fields associated with the defined scope includes determining data present in the hash map, having an association with the data associated with the defined scope. The qualifying fields may also be associated with the business dictionary available for analyzing the report document. For instance, if a formula field is defined in the scope for analyzing the report document, interface framework 110 may qualify the formula field by determining a corresponding formula structure present in the hash map, along with qualifying the formula field as a measure. In an embodiment, if interface framework 110 does not identify a corresponding formula structure present in the hash map, the user may be provided with an option of creating a formula structure in the hash map. Qualifying the fields associated with the defined scope may be described as a part of a data source definition. A data source definition includes fields, objects and their data types (e.g., numeric, non-numeric, string, and date), aggregation types for measures and dimensions (e.g., sum of, count of, and add) and the like. A data source may be represented as a universe that includes all the information about the report document. The information may be persisted in the report document that is prepared for analysis.

Based upon the qualification of the fields, one or more result objects are generated. The result objects may be described as one or more fields associated with the user defined scope for analyzing the report document. Based upon the selected fields and the result objects generated for the selected fields, interface framework 110 generates a queryable user interface (UI) element. The queryable UI element may be rendered to the user on a user interface 120. The UI element may be utilized to query the data present in the selected fields of the report document. A query may be described as a composite of the result objects, metadata of the fields, and one or more prompts that define an association between the data present in the report document and the user's input. Based upon a user input to the query, interface framework 110 extracts data from the report document through server backend 105 and loads the data on to a multi-dimensional result data. The multi-dimensional result data provides an analytical representation of the extracted data, using which the user may analyze the report document. Report analyzing console 115 may be utilized to analyze the data present in the multi-dimensional result data. In an embodiment, report analyzing console 115 utilizes the hash map created by interface framework 110 for analyzing the data present in the multi-dimensional result data. In another embodiment, report analyzing console 115 may store the multi-dimensional result data that is loaded with the extracted data.

In an embodiment, a user input to the query includes modifying one or more of the qualifications of the data source parameters associated with the user definition. For instance, the user input to the query may be for changing a dimension or a measure of a field. The process may determine a dimension or a measure for a field depending upon the data type for the contents present in the field or the field type. However, in some cases, the qualified dimension or measure may not be suitable for a particular instance, and hence, the user input to the query may include a change of measure or dimension for one or more fields. Similarly, the user input to the query may include changing or modifying the data types assigned to one or more fields, an aggregation function assigned to the measures, and the like. Based upon the user input to the query, a manner in which the report document is analyzed or a manner in which one or more calculations are performed in the process of the report document may vary.

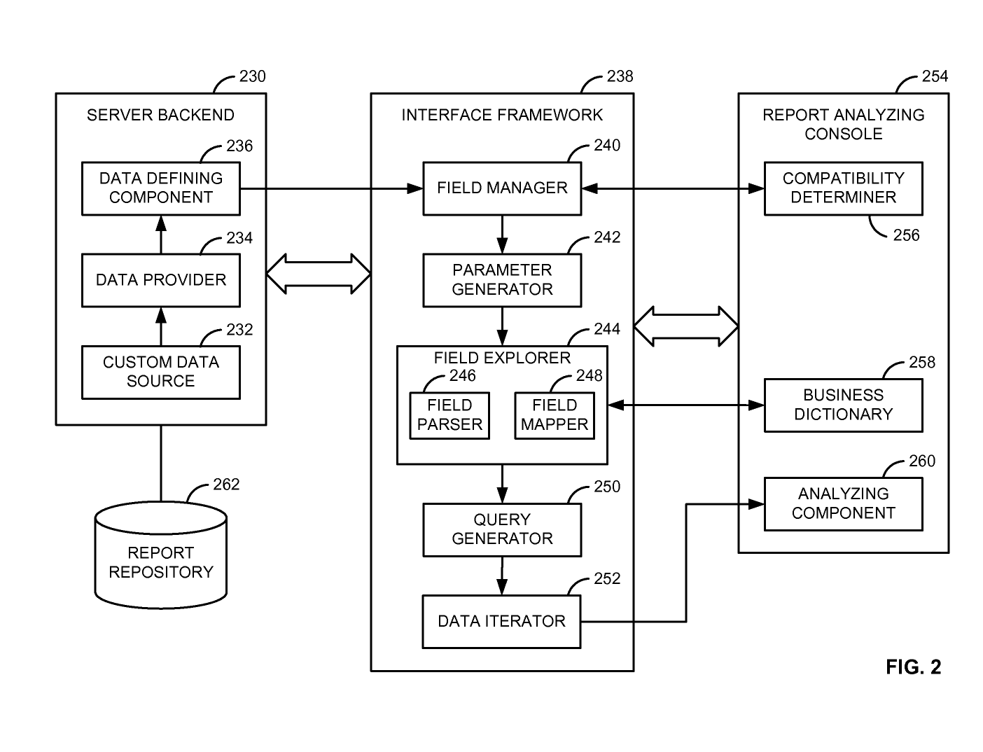

FIG. 2 is a block diagram providing an illustration of an overall architecture of a system for extracting data from a report document for analysis, according to various embodiments of the invention. A report document possesses findings and information about a corresponding business scenario. The report includes data that may exist in the form of a table, including fields and corresponding metadata. Fields of a report document represent one or more columns of the table and the corresponding metadata represent the information about the field. Report repository 262 may contain many such report documents for various business scenarios. Report repository 262 also stores the metadata associated with each of the report documents. A user may select one such report document from report repository 262 for analysis. Server backend 230 includes custom data source 232 that creates data provider 234 for the selected report document. Custom data source 232 is a data source that includes a collection of information of various report documents for various business scenarios. A custom data source may be described as an extensible data source component, that facilitates in capturing the information of the report document as a part of the data source definition. For instance, a data source definition being implemented for a report document will have a custom data source including the implementation details for the report documents, the column information, the field types and the like.

The information may contain details about the report document including type of data present in each report, structure of data, information about the business object it represents and the like. Types of custom data sources may include local files, in-memory data structures, uniform resource identifier (URI) locations, data stream and the like. The information contained in custom data source may be formatted based upon a manner in which it will be used, and may also include metadata describing the format of data. Based upon the custom data source 232, the selected report document is considered as data provider 234. Data provider 234 is a component of custom data source 232, having information about the selected report document, that recognizes the structure and the types of data and the types of fields present in the selected report document. A report definition and a data definition are extracted from data provider 234, by data defining component 236. Based upon the report definition and the data definition, data defining component 236 determines the fields and the associated metadata of the selected report document.

Interface framework 238 helps in identifying and extracting the data necessary for analysis. Field manager 240 contained in interface framework 238 categorizes the fields and the associated metadata present in data defining component 236. Based upon a compatibility of the data source parameters with report analyzing console 254 determined by compatibility determiner 256, data source parameters are generated for the categorized fields. Parameter generator 242 generates the data source parameters, and renders the data source parameters for the user to define a scope for analyzing the data present in the report document.

In an embodiment, field manager 240 may generate a hash map based upon the categorized fields. Compatibility determiner 256 may determine the compatibility of the hash map with report analyzing console 254. In an embodiment, determining compatibility may include determining whether the structure of the hash map is compatible to a structural representation of report analyzing console 254. If the structure of the hash map is compatible with the structural representation of report analyzing console 254, compatibility determiner 256 communicates to field manager 240 for further processing. If the structure of the hash map is not compatible, compatibility determiner 256 may communicate the same to field manager 240, to make necessary modification or take necessary actions to make the hash map compatible. In an embodiment, the hash map is created such that the structure of the hash map is similar to the structure of the data present in the report document. The hash map stores the structure of the data present in each field of the report document. For instance, a hash map may include the metadata specifying the type of data that a field holds.

Based upon the structure and information in the hash map, parameter generator 242 generates a structure similar to the data included in each field of the report document. In an embodiment, parameter generator 242 populates the information in the hash map based upon the data in the data definition. The data source parameters are rendered on a user interface (UI). In an embodiment, the structure in which the fields and the corresponding metadata are stored may be simplified into a set of name-value pair data source parameters, to be used as data source parameters, and for rendering the fields on the UI. The name-value pairs are stored in the hash map. In another embodiment, the fields that represent the data source parameters are rendered on the UI.

Below table “Table 1” shows a sample hash map, storing the structure of the data present in each field of the report document.

TABLE 1

| Hash map storing the structure of | | Hash map storing the structure of the |
|---|---|---|
| the data in the fields | | data in the fields as name-value pairs |
| Data Field = | FieldName - | DataFields_FieldName = |
| Store Name | Store Name | Store Name |
| | FieldValue - | DataField_FieldValue = |
| | ABC Stores | ABC Stores |
| Formula Field = | FieldName - | FormulaField_FieldName = |
| Years | Count_Years | Count_Years |
| | FieldValue - 4 | FormulaField_FieldValue = 4 |

The hash map stores the structure of data stored in the fields of the report document. For instance, in Table 1, for the data field “Store Name”, the hash map stores the structure of the data field as “FieldName—Store Name” and “FieldValue ABC Stores”, where the name of the data field is “Store Name” and the value of the data field is “ABC Stores”. Similarly for the formula field “Years”, the hash map stores the structure of the formula field as “FieldName—Count_Years” and “FieldValue—4”, where the formula assigned to the formula field “Years” is a “count” of a number of years, and the value of the formula field “4” is a result of the “count”.

The hash map also stores the structure of the data stored in the fields of the report document as name-value pairs. For instance, the hash map stores a name-value pair “DataField_FieldName=Store Name” and DataField_Field Value=ABC Stores”. Here, the name of the name-value pair is denoted as “DataField_FieldName=Store Name”, where the name of the data field is “Store Name”. And the value of the name-value pair is denoted as “DataField_FieldValue=ABC Stores”, where the value of the data field is “ABC Stores”. Thus, the type of the field and the name or the value of the field are stored as an entry in the hash map. That is, the entry “DataField_FieldName=Store Name” denotes the type of the field which is data field, and the name of the field which is the store name. Similarly, the entry “DataField_FieldValue=ABC Stores” denotes the type of the field which is data field, and the value of the field which is ABC Stores.

The user is provided with an option of defining a scope for analyzing the report document. The scope for analyzing a document determines the data that the user is interested in analyzing. The scope of analyzing the report document represents a range of data that the user wants to analyze, which is a part of the report document. In an embodiment, the defined scope may include one or more fields that the user is interested in analyzing.

Based upon the scope defined by the user, field explorer 244 explores the report document to determine the fields and the metadata associated with the defined scope. The associated fields and their metadata are qualified by field explorer 244. Qualifying the fields include determining one or more measures and dimensions corresponding to the selected fields. In an embodiment, interface framework 238 identifies the type of data present in the selected fields. In some embodiments, field explorer 244 may be associated with business dictionary 258 that includes one or more patterns and corresponding details of the selected fields that would enable the identification of the type of data present in the selected fields.

In an embodiment, qualifying the fields associated with the defined scope includes determining data present in the hash map associated with the data within the defined scope. The qualifying fields may also be associated with business dictionary 258 available for analyzing the report document. For instance, if a function field or a formula field is defined in the scope for analyzing the report document, field parser 246 included in field explorer 244 may qualify the function field or the formula field. Field parser 246 qualifies the function field or the formula field by determining a corresponding formula structure present in the hash map, along with qualifying the formula field as a measure. Field mapper 248 included in field explorer 244 may map the formula field with a corresponding formula structure present in the hash map. In an embodiment, if field parser 246 does not identify a corresponding formula structure present in the hash map, the user may be provided with an option of creating a formula structure in the hash map. Qualifying the fields associated with the defined scope may be described as a part of a data source definition. Field mapper 248 may determine the mapping based upon business dictionary 258 and the data source parameters. Business dictionary 258 may include a custom code for each of the formulae associated with the report document. The custom code may represent a mapping of the associated formula and the corresponding field.

Based upon the qualification of the fields, field explorer 244 generates result objects. Based upon the selected fields and the result objects generated for the selected fields, query generator 250 generates a queryable user interface (UI) element. The queryable UI element may be rendered to the user a UI. The UI element may be utilized to query the data present in the selected fields of the report document. Based upon a user input to the query, data iterator 252 iterates the report document to extract the data associated with the user input to the query, from the report document through server backend 230. Data iterator 252 loads the data on to a multi-dimensional result data. The multi-dimensional result data provides an analytical representation of the extracted data, using which the user may analyze the report document. Analyzing component 260 included in report analyzing console 254 may be utilized to analyze the data present in the multi-dimensional result data. In an embodiment, analyzing component 260 utilizes the hash map created by field manager 240 for analyzing the data present in the multi-dimensional result data. In another embodiment, analyzing component 260 may store the multi-dimensional result data that is loaded with the extracted data.

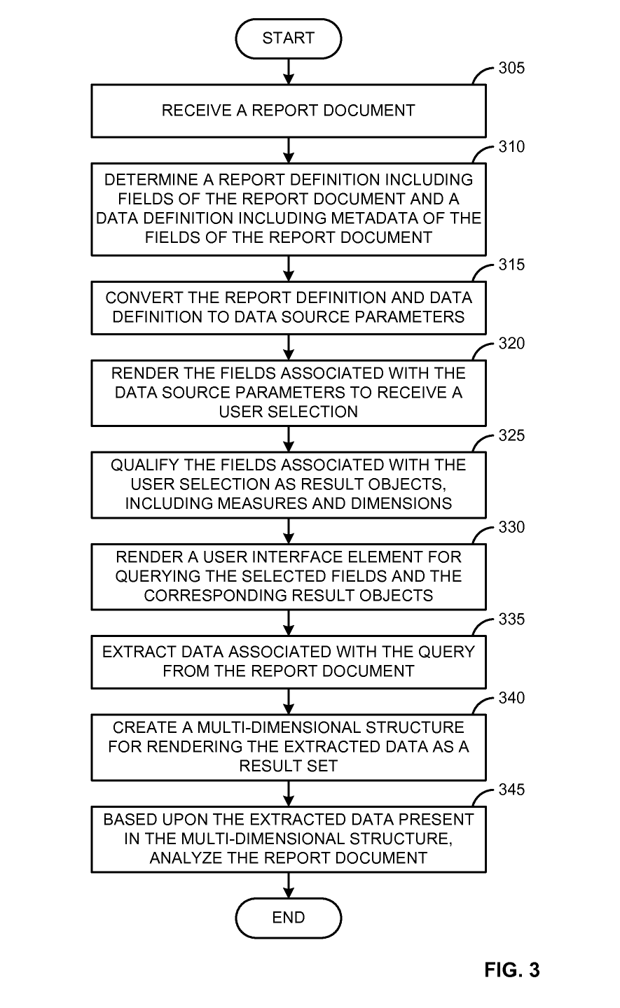

FIG. 3 is flow diagram illustrating an exemplary overall process for extracting data from a report document for analysis, according to various embodiments of the invention. In process block 305, a report document is received. In some embodiments, the report document is selected by a user. The user may select the report document from a group of report documents residing in a local memory. In process block 310, a report definition and a data definition are determined for one or more fields that the report document may include. The report definition may include the fields of the report document, and the data definition may include the metadata of the fields of the report document. In process block 315, the report definition and the data definition of the report document are converted to data source parameters. After conversion, the data source parameters include the fields and the corresponding metadata of the report document.

In process block 320, the fields associated with the data source parameters are rendered on a UI where a user defines a scope for analyzing the report document. In an embodiment, the user may select one or more fields for defining a scope for analyzing the report document. In process block 325, the fields associated with the user defined scope are qualified as result objects. Qualifying the fields may include determining measures and dimensions for the selected fields and the corresponding data present in the report document. In process block 330, a UI element is rendered on the UI for querying the selected fields and the corresponding result objects. A user input to the query is used to determine the data for analyzing the report document. In process block 335, the data associated with the query is extracted. In process block 340, a multi-dimensional structure is created for rendering the extracted data as a result set. In process block 345, based upon the extracted data present in the multi-dimensional structure, the report document is analyzed.

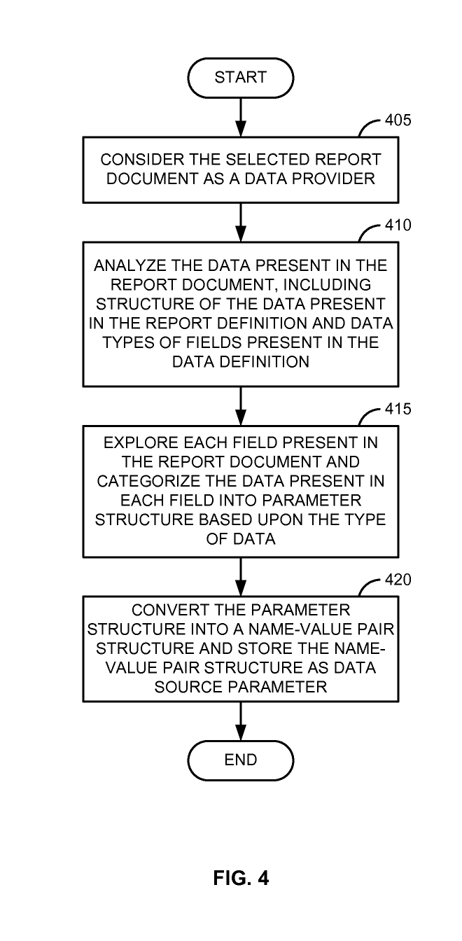

FIG. 4 is a flow diagram illustrating an exemplary process for converting the report definition and the data definition into data source parameters, according to various embodiments of the invention. To determine the report definition and the data definition of the report document, in process block 405, the report document is considered as a data provider. The data provider is created based upon the available data source of the report document. A data source may be considered as a universe for a business scenario, for instance, a report document. A data provider is created based upon the data source to query the report document and extract information from the report document. The report document is considered as a data provider to perform necessary analysis on the report document. The data provider may be representing a process (e.g., analysis) associated with querying a resource (e.g., report document). In process block 410, the data present in the report document including the structure of the data in the report definition and the data type of fields present in the data definition are analyzed. In an embodiment, the data provider will analyze the data present in the report document and the data definition.

In process block 415, each field present in the report document is explored, and the data present in each field is categorized into parameter structure based upon the type of data present in each field. The report document is explored to determine one or more types of the fields, including data fields, formula fields and the like. The fields thus explored are categorized into parameter structure. The parameter structure may represent a structure data similar to a manner in which the data is present in the data provider. In process block 420, the parameter structure is converted into a name-value pair structure and the name-value pair is stored as data source parameter. The data source parameters are presented to the user to define the scope of analysis. One or more fields associated with the scope of analysis is identified and qualified. A result object is generated for each qualified field associated with the scope of analysis. Based upon the qualified fields, a user interface (UI) element is generated to receive a user query. The user input to the query is utilized to extract data present in the fields associated with the query. The extracted data is loaded on to a multi-dimensional structure, and is rendered as a result set. Based upon the data present in the multi-dimensional structure, the report document is analyzed.

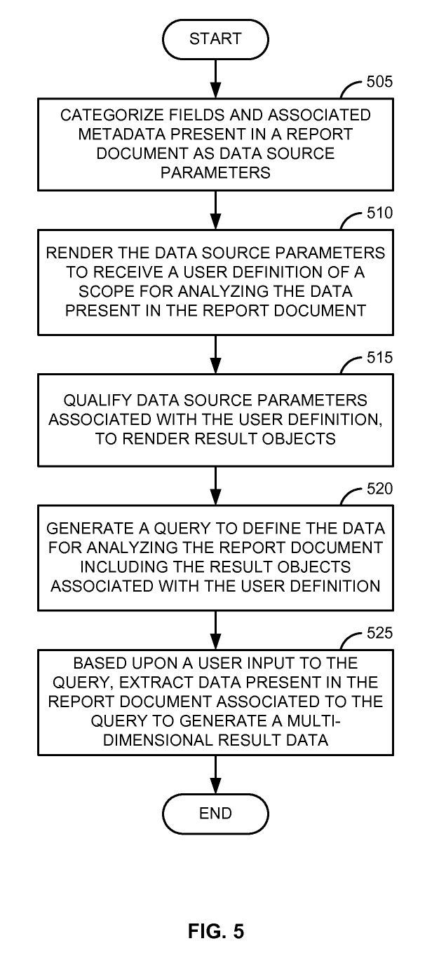

FIG. 5 is a flow diagram illustrating an exemplary process for extracting data from a report document for analysis, according to various embodiments of the invention. A user may want to analyze a part of data present in the report document. The report document may include one or more fields, and metadata associated with the fields. In process block 505, one or more fields and metadata associated with the fields are categorized as data source parameters. In process block 510, the data source parameters are rendered to receive a user definition of a scope for analyzing the data present in the report document. The data source parameters may be rendered on a user interface (UI), and the user may define the scope for analyzing by selecting one or more data source parameters represented as one or more fields. In process block 515, the data source parameters associated with the user definition are qualified, to render one or more result objects. The result objects are rendered for each of the data source parameters associated with the user definition. In process block 520, based upon the result objects, a query is generated to define the data for analyzing the report document. The query generated may be rendered on the UI for the user to specify the data for analyzing the report document. In process block 525, based upon a user input to the query, data associated with the query, present in the report document is extracted to generate a multi-dimensional result data. The data present in the multi-dimensional result data may be used utilized to analyze the report document.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media that stores one or more sets of instructions. The term “computer readable medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with computer readable software instructions.

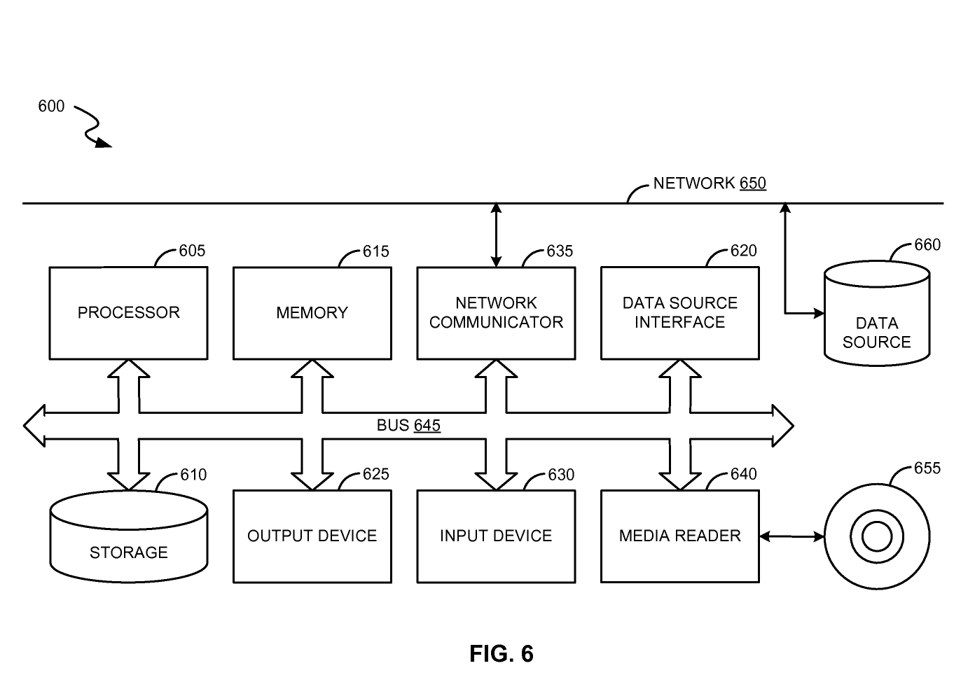

FIG. 6 is a block diagram illustrating a computing environment in which the techniques described for extracting data present in a report document for analyzing can be implemented, according to various embodiments of the invention. The computer system 600 includes a processor 605 that executes software instructions or code stored on a computer readable medium 655 to perform the above-illustrated methods of the invention. The computer system 600 includes a media reader 640 to read the instructions from the computer readable medium 655 and store the instructions in storage 610 or in random access memory (RAM) 615. The storage 610 provides a space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660 at a server computer system. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include data stored in a report document, tabular data (e.g., spreadsheets, delimited text files), data tagged with a markup language (e.g., XML data), transactional data, unstructured data (e.g. text files, screen scrapings), hierarchical data (e.g., data in a file system, XML data), files, a plurality of reports, and any other data source accessible through an established protocol, such as, Open DataBase Connectivity (ODBC), produced by an underlying software system (e.g. ERP system), and the like. Data sources may also include a data source where the data is not tangibly stored or otherwise ephemeral such as data streams, broadcast data, and the like. These data sources can include associated data foundations, semantic layers, management systems, security systems and so on.

The report document may be residing in storage 620 or memory 615 of system 600. A report document contains data, including data specific to one or more instances of the business scenario. Fields and metadata associated with the fields that are included in the report document represent a particular instance or a property of an element in the report document. In an embodiment, the metadata associated with the fields of the report document is stored in storage 620. To analyze such instances or properties of elements present in a report document of a business scenario, data of the corresponding instances are extracted. To provide an option of choosing the instances of the business scenario for analysis, a group of report documents that represent one or more business scenarios are presented to the user. The user may select one such report document for analyzing. Based upon the selected report document, metadata associated with the report document is retrieved. The metadata of the business document has details of the business document including the information about fields of the business scenario. The fields of the selected report document are presented to the user to define a scope for analyzing the report document. The scope for analyzing the report document represents range of data that the user wants to analyze, which is a part of the report document. The defined scope may include one or more fields that the user may want to analyze. Based upon the scope defined by the user, the fields associated with the defined scope are determined, and categorized to data source parameters. The data source parameters that represent the associated fields and their metadata are presented to the user. The user is given an option of querying the report document using the associated fields. By querying the report document using the associated fields, the user will be able to extract the data of interest, for analyzing the report document. Based upon the query defined by the user, the data is extracted from the report document and loaded on to a multi-dimensional result data. The multi-dimensional result data provides an analytical representation of the extracted data, using which the user may analyze the report document.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

I/We claim:

1. An article of manufacture, comprising a computer-accessible medium comprising instructions that, when executed by a computer, cause the computer to execute a method for extracting data from a report document for analysis, the method comprising:
categorizing one or more fields and associated metadata present in the report document as one or more corresponding data source parameters;
rendering the data source parameters to receive a user definition of a scope for analyzing the data present in the report document;
qualifying one or more data source parameters associated with the user definition, to render one or more result objects for each associated data source parameter;
based upon the data source parameters and the result objects, generating a query to define the data for analyzing the report document, the query including the result objects associated with the user definition; and
based upon a user input to the query, extracting data present in the report document associated to the query to generate a multi-dimensional result data.

2. The article of manufacture of claim 1, wherein the method further comprises:
receiving a user selection of a report document for a group of one or more report document;
identifying one or more fields and associated metadata present in the report document;
generating a report definition for the fields of the report document and a data definition for the metadata associated with the fields of the report document; and
converting the report definition and the data definition of the report document to the data source parameters.

3. The article of manufacture of claim 1, wherein categorizing the fields further comprises:
exploring the fields present in the report document to identify the metadata associated with the fields;
determining a field type for each of the fields based upon the metadata associated with the field;
based upon the field type of each of the fields, categorizing the data present in the corresponding field into parameter structure;
converting each parameter structure into a name name-value pair structure; and
rendering the name-value pair structure as the data source parameter.

4. The article of manufacture of claim 1, wherein categorizing the fields and the metadata associated with the fields comprises:
generating a hash map, the hash map including a structure comprising arrangement of the fields and contents associated with the fields in the report document;
based upon a data definition of the report document, populating the hash map by supplying the contents associated with the fields of the report document to the hash map; and
based upon the contents of the hash map, rendering the data source parameters.

5. The article of manufacture of claim 1, wherein defining the scope for analyzing the report document further comprises defining one or more fields associated with the scope for analyzing the report document.

6. The article of manufacture of claim 1, wherein qualifying the data source parameters further comprises:
determining one or more fields associated with the scope for analyzing the report document; and
determining one or more measures and one or more dimensions corresponding to the fields, the measures and dimensions determined based upon a field type of each field.

7. The article of manufacture of claim 6, wherein qualifying the data source parameters comprises determining contents of a hash map having an association with the scope for analysis.

8. The article of manufacture of claim 7, wherein the method of determining the contents of a hash map comprises:
parsing one or more fields associated with the scope for analysis, to determine one or more corresponding field functions in the hash map; and
mapping the functions to the corresponding fields associated with the scope for analysis.

9. The article of manufacture of claim 8, wherein determining the contents of the hash map further comprises providing an option for creating a field function in the hash map, if the fields associated with the scope for analysis does not include a corresponding function in the hash map.

10. The article of manufacture of claim 7, wherein the hash map determines a corresponding field function from a business dictionary, the business dictionary including the field functions of the fields of the report document.

11. The article of manufacture of claim 1, wherein the method of rendering the result objects comprises identifying one or more fields associated with the scope for analyzing the report document.

12. The article of manufacture of claim 1, wherein the user input to the query comprises: performing a modification to one or more qualifications of the data source parameters associated with the user definition.

13. The article of manufacture of claim 12, wherein the method of performing a modification comprises performing an action from a group consisting of modifying a qualification of one or more fields, modifying a data type of one or more fields, modifying one or more dimensions, modifying one or more measures, and modifying an aggregation function to be performed on one or more measures.

14. The article of manufacture of claim 1, wherein the method of extracting the data present in the report document includes iterating the report document to determine the data associated with the user input to the query.

15. The article of manufacture of claim 1, wherein the method further comprises:
determining compatibility between a structure of a hash map and a structural representation of the report document.

16. A computer implemented method for extracting data from a report document for analysis, the method comprising:
categorizing one or more fields and associated metadata present in the report document as one or more corresponding data source parameters;
rendering the data source parameters to receive a user definition of a scope for analyzing the data present in the report document;
qualifying one or more data source parameters associated with the user definition, to render one or more result objects for each associated data source parameter;
based upon the data source parameters and result objects, generating a query to define the data for analyzing the report document, the query including the result objects associated with the user definition; and
based upon a user input to the query, extracting data present in the report document associated to the query to generate a multi-dimensional result data.

17. A computing device operable for extracting data from a report document for analysis comprising:
a processor operable for reading and executing instructions stored in one or more memory elements; and
the one or more memory elements storing instructions for:
a field manager operable for categorizing one or more fields and associated metadata present in the report document as one or more corresponding data source parameters;
a parameter generator operable for rendering the data source parameters to receive a user definition of a scope for analyzing the data present in the report document;
a field explorer operable for qualifying one or more data source parameters associated with the user definition, to render one or more result objects for each associated data source parameter;
a query generator operable for generating a query based upon the result objects, to define the data for analyzing the report document; and
a data iterator operable for extracting data present in the report document associated to the query based upon a user input to the query, to generate a multi-dimensional result data.

18. The computing device of claim 17 further comprising a field parser operable for parsing the fields associated with the scope for analysis and qualifying a function field by determining a corresponding function structure in a hash map.

19. The computing device of claim 17 further comprising a field mapper operable for mapping a function field with a corresponding function structure present in a hash map.

20. The computing device of claim 17 further comprising a compatibility determiner operable for determining a compatibility between a structure of a hash map and a structural representation of the report document.
